(19) United States
(12) Patent Application Publication
(10) Pub. No.: US 2019/0113671 A1
(43) Pub. Date: Apr. 18, 2019

(54) DISPLAY APPARATUS AND BACKLIGHT MODULE

(71) Applicant: Wuhan China Star Optoelectronics Semiconductor Display Technology Co., Ltd., Wuhan (CN)

(72) Inventor: Xuanyun Wang, Shenzhen (CN)

(21) Appl. No.: 15/740,565

(22) PCT Filed: Nov. 23, 2017
(86) PCT No.: PCT/CN2017/112617

§ 371 Date: Aug. 27, 2018

(30) Foreign Application Priority Data
Oct. 18, 2017 (CN) 201710976561.9

(51) Int. Cl. F21V 8/00; G02F 1/1335

(52) U.S. Cl. CPC G02B 6/0035; G02B 6/0055; G02B 6/0031; G02F 2203/09; G02F 2001/133562; G02F 2001/133567; G02F 2203/023; G02F 1/133528

(57) ABSTRACT

A display apparatus and a backlight module are disclosed. The backlight module includes a light emitting assembly, configured to generate display lights; and a light guiding plate, configured to transmit the display lights to the display panel. The light guiding plate is divided into reflective areas and transmission areas; each medium in the reflective areas has a refractive index greater than that of each medium in the transmission areas. In this application, two media with different refractive indices are provided in the light guiding plate. In this way, the utilization rate of the energy of the back light source may be improved, the consumption of the display may be reduced, the power may be saved and the battery life of the display apparatus may also be extended.

### CROSS-REFERENCE TO RELATED APPLICATIONS

The present application is a 35 U.S.C. § 371 National Phase conversion of International (PCT) Patent Application No. PCT/CN2017/112617 filed Nov. 23, 2017, which claims foreign priority to Chinese Patent Application No. 201710976561.9, filed on Oct. 18, 2017 in the State Intellectual Property Office of China, the entire contents of which are hereby incorporated by reference.

### TECHNICAL FIELD

The present disclosure relates to the display technology, and more particular, to a display apparatus and a backlight module.

### BACKGROUND

Generally, liquid crystal display panels are each formed by a color filtering substrate and an array substrate aligned with each other. A liquid crystal layer is packed within the space between the color filtering substrate and the array substrate. Since liquid crystal molecules are non-luminous, the display panels need extra light sources to display images. The liquid crystal display panels may be divided into transmissive liquid crystal display panels, reflective liquid crystal display panels, and transflective liquid crystal display panels, based on types of the used light sources.

The transmissive liquid crystal display panels mainly use back light sources as the light sources, in which case the back light sources are arranged on backs of liquid crystal panels, and pixel electrodes on the array substrates are transparent such that the pixel electrodes are used as transmission areas, thereby facilitating the transmission of lights emitted from the back light sources through the liquid crystal layers to display images. The reflective liquid crystal display panels mainly use front light sources or external light sources as the light sources, in which case reflective electrodes on the array substrates, which are made from metals or other materials having good reflectivity, are used as reflective areas suitable for reflecting the lights emitted from the front light sources or the external light sources. The transflective liquid crystal display panels can be regarded as a combination of the transmissive liquid crystal display panels and the reflective liquid crystal display panels, in which case both the transmission areas and the reflective areas are formed on the array substrates, and thus it is possible to use the back light sources as well as the front light sources or the external light sources simultaneously to display images.

The transmissive liquid crystal display panels are capable of displaying bright images in dark environment; however, only a small proportion of the lights emitted from the back light sources can be transmitted through the transmissive liquid crystal display panels, and the back light sources has a low utilization rate. Thus, it needs to greatly improve the brightness of the back light sources in order to improve the displaying brightness, and the display panels are energy-wasting. The reflective liquid crystal display panels are capable of utilizing external light sources and have low energy consumption; however, the reflective liquid crystal display panels cannot display images in the dark environment due to the dependence on the external light sources. The transflective liquid crystal display panels absorb the advantages of the transmissive liquid crystal display panels and the reflective liquid crystal display panels. The transflective liquid crystal display panels can be used in indoor to display bright images in the dark environment, or used in outdoor. Therefore, the transflective liquid crystal display panels are widely used in display apparatuses of portable mobile electronic products, such as mobile phones, digital cameras, palmtops, GPRS, or the like.

In a conventional transflective liquid crystal display, the lights emitted from the back light source may be incident to the transmission area and the reflective areas simultaneously. The lights incident into the transmission area are effectively used, while the lights incident into the reflective area are completely blocked due to the reflective layer (made from metal), and thus the lights incident into the reflective area are wasted.

Therefore, it is necessary to develop a new liquid crystal display apparatus and a backlight module.

### SUMMARY

The objective of the present disclosure is to provide a liquid crystal display apparatus and a backlight module, which can improve the utilization rate of the back light sources, and reduce the energy consumption of the display apparatus.

To solve the technical problems above, in one aspect, a technical solution is adopted in the present application to provide a backlight module used in a transflective display panel. The backlight module includes a light emitting assembly, configured to generate display lights; a light guiding plate, configured to transmit the display lights to the display panel; and a first reflective layer, arranged at a bottom of the light guiding plate; wherein the light guiding plate is divided into reflective areas and transmission areas; each medium in the reflective areas has a refractive index greater than that of each medium in the transmission areas; each medium in the reflective areas is a total reflection medium.

To solve the technical problems above, in another aspect, another technical solution is adopted in the present application to provide a backlight module used in a transflective display panel. The backlight module includes a light emitting assembly, configured to generate display lights; and a light guiding plate, configured to transmit the display lights to the display panel; wherein the light guiding plate is divided into reflective areas and transmission areas; each medium in the reflective areas has a refractive index greater than that of each medium in the transmission areas.

To solve the technical problems above, in a further aspect, a further technical solution is adopted in the present application to provide a liquid crystal display apparatus. The liquid crystal display apparatus includes a backlight module and a display panel; wherein the display panel is divided into reflective areas and transmission areas; the backlight module includes: a light emitting assembly, configured to generate display lights; and a light guiding plate, configured to transmit the display lights to the display panel; wherein the light guiding plate is divided into reflective areas and transmission areas; each medium in the reflective areas has a refractive index greater than that of each medium in the transmission areas.

The present disclosure may have the following advantages: compared with the related art, in the present disclosure, two media with different refractive indices are provided in the light guiding plate. In this way, it is possible to ensure that the lights emitted from the back light source can only be transmitted out through projection positions on the transmission areas, and will not be transmitted out through projection positions on the reflective areas, thus the utilization rate of the energy of the back light source may be improved. In the liquid crystal display apparatus, the consumption of the display may be reduced, the power may be saved and the battery life of the display apparatus may also be extended.

### BRIEF DESCRIPTION OF THE DRAWINGS

FIG. 1 is a schematic view of a backlight module according to an embodiment of the present disclosure.

FIG. 2 is a schematic view of a liquid crystal display apparatus according to an embodiment of the present disclosure.

### DETAILED DESCRIPTION

The technical solution of the embodiments of the present application will be described more clearly and completely with reference to the accompanying drawings. Apparently, the embodiments described here only some exemplary embodiments, not all the embodiments. Based on the embodiments described in the present application, one skilled in the art may acquire all other embodiments without any creative work. All these shall be covered within the protection scope of the present application.

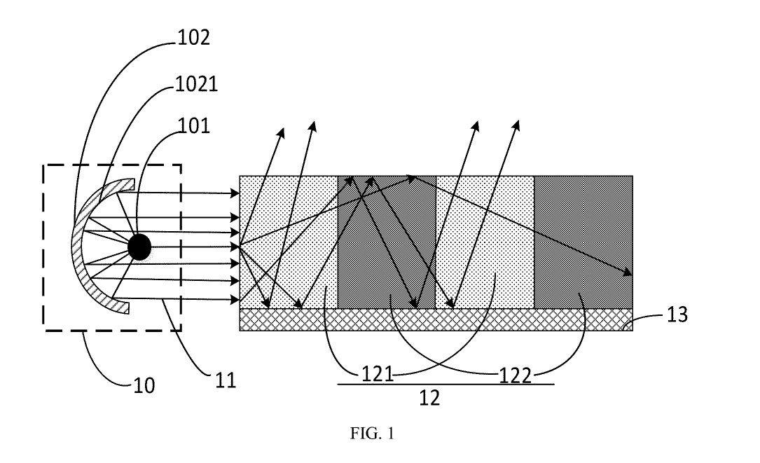

Referring to FIG. 1, a schematic view of a backlight module according to an embodiment of the present disclosure is depicted in FIG. 1. As shown in FIG. 1, in this embodiment, the backlight module used in a transflective display panel may include a light emitting assembly 10 and a light guiding plate 12. The light emitting assembly 10 may be configured to generate display lights 11. The light guiding plate 12 may be configured to transmit the display lights 11 generated by the light emitting assembly 10 to the display panel. A first reflective layer 13 may be arranged at a bottom of the light guiding plate 12, and configured to further reflect and utilize the lights incident into the bottom of the light guiding plate 12, thereby improving the utilization rate of the lights. In this embodiment, the first reflective layer 13 may be made from aluminum foil. The light guiding plate 12 may be divided into reflective areas 122 and transmission areas 121, and the reflective areas 122 and the transmission areas 121 are alternately distributed on the light guiding plate 12. Each medium in the reflective areas 122 has a refractive index greater than that of each medium in the transmission areas 121. It should be noted that, only two reflective areas 122 and two transmission areas 121 are shown in FIG. 1. However, in other embodiments, the numbers respectively of the reflective areas 122 and the transmission areas 121 may be selected as required, and will not be limited here.

The light emitting assembly 10 may include a light bar 101 and a lampshade 102. The lampshade 102 may include a second reflective layer 1021. The light bar 101 may be configured to generate the display lights 11, while the second reflective layer 1021 may be configured to reflect the display lights to the light guiding plate 12. In this embodiment, the light bar 101 may be implemented as a LED light bar; the lampshade 102 may be in shape of a parabola, and the second reflective layer 1021 may be made from aluminum foil. A light exit surface and a light incident surface of the light guiding plate 12 may be perpendicular to each other, and the reflective areas 122 and the transmission areas 121 are alternately distributed on the light guiding plate 12. The media in the reflective areas 122 may be total reflection media, in such a way that when the lights exited from the total reflection media are incident into the air, the lights may be totally reflected, and thus it is possible to ensure that the lights will not be transmitted out through the reflective areas 122. The media in the transmission areas 121 may be incomplete reflection media, in such a way that when the lights exited from the incomplete reflection media are incident into the air, the lights will not be totally reflected, and thus it is possible to ensure that the lights will be transmitted out through the reflective areas 122.

In this embodiment, the light bar 101 is implemented as a LED light bar, the lampshade 102 is in shape of a parabola, and the second reflective layer 1021 is made from aluminum foil. However, in other embodiments, it is also possible that the light bar 101 may be implemented as other suitable light bar such as a fluorescent lamp or the like. It is also possible to provide at least two light bars in this embodiment. The lampshade 102 may also be in other shapes, such as in shape of an arc or the like. The first reflective layer 103 and the second reflective layer 1021 may also be made from other metal materials, such as silver or the like. All these will not be limited in the present disclosure.

In this embodiment, the media in the reflective areas 122 are total reflection media, while the media in the transmission areas 121 are incomplete reflection media, and each total reflection medium has a refractive index greater than that of each incomplete reflection medium. In other embodiments, it is also possible that the media in the reflective areas 122 are not total reflection media, as long as each medium in the reflective areas 122 has a refractive index closer to the total reflection medium, and greater than that of each medium in the transmission areas 121. All these will not be limited in the present disclosure.

In this embodiment, the first reflective layer 13 is arranged at the bottom of the light guiding plate 12. However, in other embodiment, it is also possible that the light guiding plate 12 is provided without the first reflective layer 13. It should be noted that, the first reflective layer 13 is configured to further reflect and utilize the lights incident into the bottom of the light guiding plate 12. Although parts of the lights may be wasted due to the removal of the first reflective layer 13; however, a thickness of the light guiding plate 12 may be reduced in this way. Therefore, whether arranging the first reflective layer 13 or not may be determined as required, and will not be limited in the present disclosure.

The transmission processes of the lights in this embodiment are as follow. Divergent display lights 11 may be emitted from the light bar 101, and further normally incident into the light guiding plate 12, or incident into the light guiding plate 12 after being reflected by the second reflective layer 1021. The display lights 11 incident into the light guiding plate 12 may include 3 transmission ways: (1) The display lights 11 are incident to the transmission areas 121 and further directly transmitted out through the transmission areas 121. (2) The display lights are incident to the reflective areas 122, totally reflected by the total reflection media, repeatedly reflected by the total reflection media and the first reflective layer 13, and finally transmitted out through the transmission areas 121. (3) The display lights are incident to the bottom of the light guiding plate 12, reflected by the first reflective layer 13, repeatedly reflected by the total reflection media and the second reflective layer 1021, and finally transmitted out through the transmission areas 121. That is to say, the display lights 11 emitted from the light bar can be completely subjected to total transmission, and completely transmitted out through the transmission areas 121 using total transmission, thus the energy consumption is less, and the utilization rate of the light energy is improved.

Compared with the related art, in the present disclosure, two media with different refractive indices are provided in the light guiding plate. In this way, the utilization rate of the energy of the back light source may be improved, the consumption of the display may be reduced, the power may be saved and the battery life of the display apparatus may also be extended.

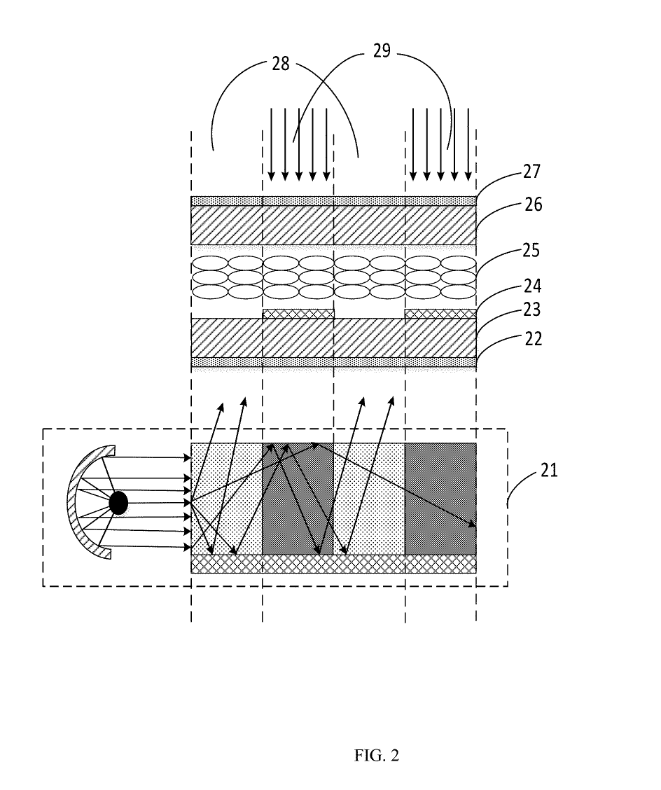

Referring to FIG. 2, a schematic view of a liquid crystal display apparatus according to an embodiment of the present disclosure is depicted in FIG. 2. As shown in FIG. 2, the liquid crystal apparatus may include a backlight module 21 and a display panel. The backlight module 21 (shown in FIG. 1) has been already described above, and will not be described here anymore. Combing with FIG. 1 and FIG. 2, the display panel may include a lower polarizer 22, a lower substrate 23, a liquid crystal layer 25, an upper substrate 26 and an upper polarizer 27 arranged successively. The liquid crystal display apparatus may be divided into reflective areas 29 and transmission areas 28, and the reflective areas 29 and transmission areas 28 are alternately distributed on the display apparatus. A third reflective layer 24 may be further provided between the lower substrate 23 and the liquid crystal layer 25 in the reflective areas 29 of the display panel. The third reflective layer 24 may be made from metal materials such as silver, aluminum, or the like. In the backlight module 21, each medium in the light guiding plate 11 and corresponding to the reflective areas 29 may have a refractive index greater than that of each medium in the light guiding plate 11 and corresponding to the transmission areas 28.

In specific, the media in the light guiding plate 11 and corresponding to the reflective areas 29 may be total reflection media.

The working principle of the display apparatus 11 may be as follow. The lights emitted from the backlight module 21 may be incident into the display panel from the transmission areas 28, and further transmitted out from the display panel through the transmission areas 28 after passing through the lower polarizer 22, the lower substrate 23, the liquid crystal layer 25, the upper substrate 26 and the upper polarizer 27. The lights incident into the reflective areas 29 may pass through the upper polarizer 27, the upper substrate 26 and the liquid crystal layer 25, further be reflected by the third reflective layer 24, and finally transmitted out through the reflective areas 29 above the third reflective layer 24 after passing through the liquid crystal layer 25, the upper substrate 26 and the upper polarizer 27.

Compared with the related art, in the present disclosure, two media with different refractive indices are provided in the light guiding plate. In this way, the utilization rate of the energy of the back light source may be improved, the consumption of the display may be reduced, the power may be saved and the battery life of the display apparatus may also be extended.

The descriptions above are merely the embodiments of the present disclosure, and are not intended to limit the protection scope of the present disclosure. In fact, one skilled in the art may make many equivalents and modifications based on the specification and the drawings of the present disclosure, or directly or indirectly apply these to other relevant technical fields. All these shall all be covered within the protection of the disclosure.

1-16. (canceled)

17. A backlight module used in a transflective display panel, comprising:
a light emitting assembly, configured to generate display lights;
a light guiding plate, configured to transmit the display lights to the transflective display panel;
a first reflective layer, arranged at a bottom of the light guiding plate;
wherein the light guiding plate is divided into reflective areas and transmission areas, and a first medium in the reflective areas has a refractive index greater than that of a second medium in the transmission areas; and
the first medium is a total reflection medium.

18. The backlight module of claim 17, wherein the reflective areas and the transmission areas are alternately distributed on the light guiding plate.

19. The backlight module of claim 17, wherein the light emitting assembly comprises:
a light bar, configured to generate the display lights; and
a lampshade, comprising a second reflective layer; wherein the second reflective layer is configured to reflect the display lights to the light guiding plate.

20. The backlight module of claim 19, wherein the first reflective layer and the second reflective layer are made from metals.

21. A backlight module used in a transflective display panel, comprising:
a light emitting assembly, configured to generate display lights; and
a light guiding plate, configured to transmit the display lights to the transflective display panel;
wherein the light guiding plate is divided into reflective areas and transmission areas, and a first medium in the reflective areas has a refractive index greater than that of a second medium in the transmission areas.

22. The backlight module of claim 21, further comprising a first reflective layer arranged at a bottom of the light guiding plate.

23. The backlight module of claim 21, wherein the first medium is a total reflection medium.

24. The backlight module of claim 21, wherein the reflective areas and the transmission areas are alternately distributed on the light guiding plate.

25. The backlight module of claim 21, wherein the light emitting assembly comprises:
a light bar, configured to generate the display lights; and
a lampshade, comprising a second reflective layer; wherein the second reflective layer is configured to reflect the display lights to the light guiding plate.

26. The backlight module of claim 25, wherein the first reflective layer and the second reflective layer are made from metals.

27. The backlight module of claim 21, wherein the second medium is an incomplete reflection medium.

28. The backlight module of claim 21, wherein the display lights emitted from the light emitting assembly are subjected to a total transmission, and completely transmitted out through the transmission areas.

29. A liquid crystal display apparatus, comprising a backlight module and a display panel;
wherein
the display panel is divided into reflective areas and transmission areas;
the backlight module comprises:
a light emitting assembly, configured to generate display lights; and
a light guiding plate, configured to transmit the display lights to the display panel;
wherein a first medium in the light guiding plate and corresponding to the reflective areas has a refractive index greater than that of a second medium in the light guiding plate and corresponding to the transmission areas.

30. The liquid crystal display apparatus of claim 29, wherein the backlight module further comprises a first reflective layer arranged at a bottom of the light guiding plate.

31. The liquid crystal display apparatus of claim 29, wherein the first medium is a total reflection medium.

32. The liquid crystal display apparatus of claim 29, wherein the reflective areas and the transmission areas are alternately distributed on the light guiding plate.

33. The liquid crystal display apparatus of claim 29, wherein the light emitting assembly comprises:
a light bar, configured to generate the display lights; and
a lampshade, comprising a second reflective layer; wherein the second reflective layer is configured to reflect the display lights to the light guiding plate.

34. The liquid crystal display apparatus of claim 29, wherein the first reflective layer and the second reflective layer are made from metals.

35. The liquid crystal display apparatus of claim 29, wherein the display panel comprises a lower polarizer, a lower substrate, a liquid crystal layer, an upper substrate and an upper polarizer arranged successively.

36. The liquid crystal display apparatus of claim 29, wherein a third reflective layer is further provided between the lower substrate and the liquid crystal layer in the reflective areas of the display panel.
